(19) United States
(12) Patent Application Publication
(10) Pub. No.: US 2025/0304151 A1
(43) Pub. Date: Oct. 2, 2025

(54) WORK VEHICLE

(71) Applicant: Yanmar Holdings Co., Ltd., Osaka (JP)

(72) Inventors: Ken MORISHITA, Okayama-shi (JP); Fumihiro EGAWA, Okayama-shi (JP); Naoki YAMAMOTO, Okayama-shi (JP)

(73) Assignee: Yanmar Holdings Co., Ltd., Osaka (JP)

(21) Appl. No.: 19/090,141

(22) Filed: Mar. 25, 2025

(30) Foreign Application Priority Data
Mar. 26, 2024 (JP) 2024-049962

(51) Int. Cl. B62D 5/26; B60B 35/16; B62D 5/06; B62D 49/06

(52) U.S. Cl. CPC B62D 5/26; B62D 5/062; B62D 49/06; B60B 35/16

(57) ABSTRACT

A tractor includes an axle case that houses an axle of a wheel, a hydraulic cylinder that is attached to the axle case, a hydraulic valve that supplies hydraulic oil to the hydraulic cylinder, and a supply pipe that connects the hydraulic valve to the hydraulic cylinder and through which the hydraulic oil flows. The supply pipe includes a flexible pipe and a rigid pipe. A first end portion of the rigid pipe is connected to the hydraulic cylinder. A second end portion of the rigid pipe is connected to a first end portion of the flexible pipe.

### TECHNICAL FIELD

The present invention relates to a work vehicle.

### BACKGROUND ART

A work vehicle in which an axle housed in a cylindrical axle case is supported by a frame is conventionally known. For example, in a tractor of Patent Document 1, a front axle case is supported by a bottom portion of a front axle frame by bolting.

In recent years, a swing axle suspension is mainstream. In the swing axle suspension, an axle case swings according to the shape of a road surface during travel.

### PRIOR ART DOCUMENT

### Patent Document

Patent Document 1: Japanese Unexamined Patent Application Publication No. 2015-189380

### SUMMARY OF INVENTION

### Technical Problem

However, in the swing axle suspension, a power steering cylinder attached to the axle case also swings. Accordingly, a supply pipe (made of, for example, rubber) that supplies hydraulic oil to the power steering cylinder is also displaced and is more likely to be significantly displaced particularly near the axle case. Thus, the displaced portion may interfere with a peripheral component disposed near the axle case.

In view of the above circumstances, an object of the present invention is to prevent interference of a hydraulic oil supply pipe with a peripheral component disposed near an axle case.

### Solution to Problem

In order to achieve the above-described object, a work vehicle according to an aspect of the present invention includes an axle case, a hydraulic cylinder, a hydraulic valve, and a supply pipe through which hydraulic oil flows. The axle case houses an axle of a wheel. The hydraulic cylinder is attached to the axle case. The hydraulic valve supplies hydraulic oil to the hydraulic cylinder. The supply pipe connects the hydraulic valve to the hydraulic cylinder. The supply pipe includes a flexible pipe and a rigid pipe. A first end portion of the rigid pipe is connected to the hydraulic cylinder. A second end portion of the rigid pipe is connected to a first end portion of the flexible pipe.

Additional features and advantages of the present invention will become more apparent from the following embodiment.

### Advantageous Effects of Invention

The present invention can prevent interference of a hydraulic oil supply pipe with a peripheral component disposed near an axle case.

### BRIEF DESCRIPTION OF DRAWINGS

FIG. 1 is a right side view of a tractor according to an embodiment.

FIG. 2A is a cross-sectional view of a configuration example of a front axle as viewed from the upper side.

FIG. 2B is a cross-sectional view of another configuration example of the front axle as viewed from the upper side.

FIG. 3 is a cross-sectional view of a configuration example of an inner peripheral surface of a front axle case as viewed from the upper side.

FIG. 4 is a perspective view of a configuration example of a power steering mechanism.

FIG. 5 is a rear view of the front axle as viewed from the rear side.

FIG. 6 is an external view of an example of an audio device attached to a boarding portion.

FIG. 7 is an exploded perspective view of an example of an attachment structure of the audio device.

FIG. 8 is a flowchart illustrating an example of a method of attaching the audio device.

### DESCRIPTION OF EMBODIMENTS

An embodiment of the present invention will be described below with reference to the drawings.

### 1. Embodiment

### <1-1. Tractor 100>

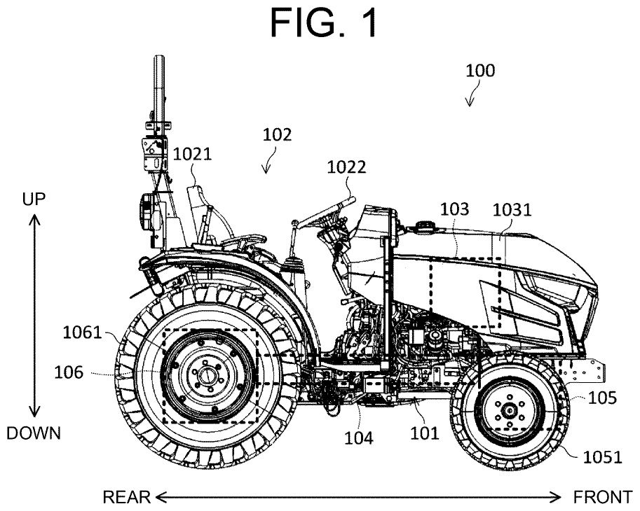

FIG. 1 is a right side view of a tractor 100 according to an embodiment. The tractor 100 according to the embodiment is an agricultural work vehicle. The tractor 100 includes a frame 101, a boarding portion 102, an engine 103, a transmission 104, a front axle 105, and a rear axle 106.

The frame 101 is a framework of the tractor 100. The frame 101 constitutes, together with the transmission 104, the front axle 105, and the rear axle 106, a chassis of the tractor 100. The engine 103 and the boarding portion 102 are supported by the frame 101 via a buffer member such as a rubber vibration isolator.

The boarding portion 102 is disposed on the chassis in a rear portion of the tractor 100. A seat 1021 and a steering wheel 1022 are disposed in the boarding portion 102. Furthermore, an accelerator pedal, a shift lever, and the like (none of them is illustrated) are disposed in the boarding portion 102. An operator who sits in the seat 1021 steers the tractor 100 by operating the steering wheel 1022, the accelerator pedal, the shift lever, and the like.

The tractor 100 in FIG. 1 is a ROPS type tractor in which no ceiling is provided and the seat 1021 is open. However, the present invention is not limited to this example, and the tractor 100 may be a canopy type tractor in which a ceiling is provided and the seat 1021 is open, or a cabin type tractor that includes a box-shaped steering cabin (corresponding to the boarding portion 102) having a ceiling, a door, and the like.

The engine 103 is, for example, a diesel engine, and is mounted on a front portion of the tractor 100 and covered with a hood 1031. The engine 103 combusts fuel to obtain thermal energy, and converts the thermal energy into kinetic energy. That is, the engine 103 generates rotational power by fuel combustion. The engine 103 is controlled by an electronic control unit (ECU; not illustrated). The ECU drives the engine 103 according to an operation of the accelerator pedal performed by the operator.

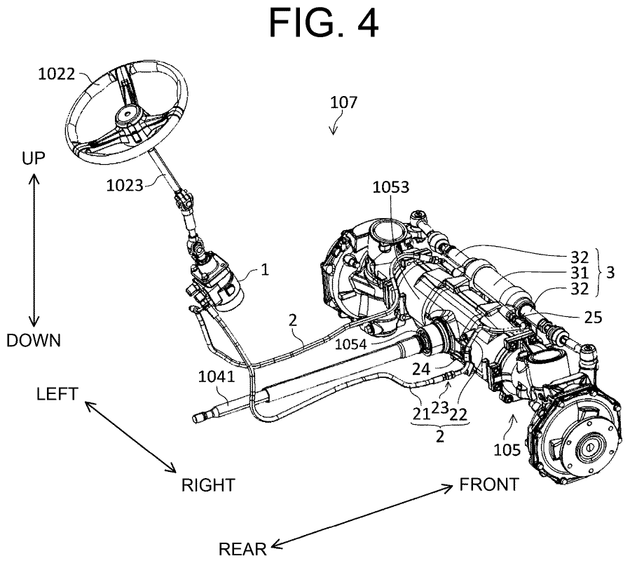

The transmission 104 transmits the rotational power of the engine 103 to the front axle 105 and the rear axle 106 via a propeller shaft 1041 (see FIG. 4 described below). The transmission 104 includes, for example, a continuously variable transmission such as a hydro static transmission (HST) or a hydro mechanical transmission (HMT). The continuously variable transmission actuates the transmission 104 in various manners according to an operation of the shift lever performed by the operator.

The front axle 105 transmits, to front wheels 1051, the rotational power of the engine 103 output via the transmission 104. The rear axle 106 transmits, to rear wheels 1061, the rotational power of the engine 103 output via the transmission 104. The front wheels 1051 and the rear wheels 1061 are driven and rotated by the rotational power of the engine 103 transmitted via the transmission 104 and the axles 105 and 106. Thus, the tractor 100 can travel forward and backward.

### <1-2. Front Axle 105>

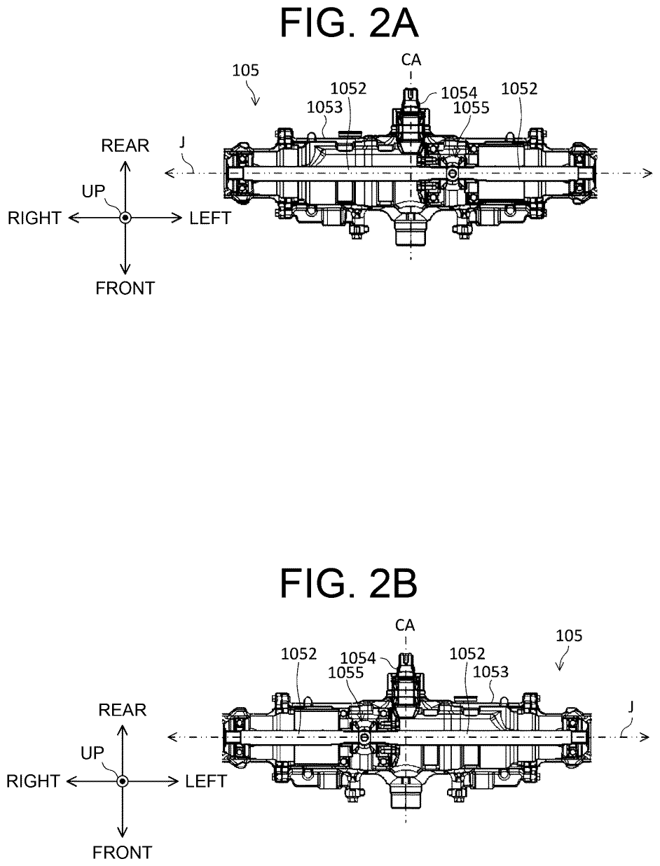

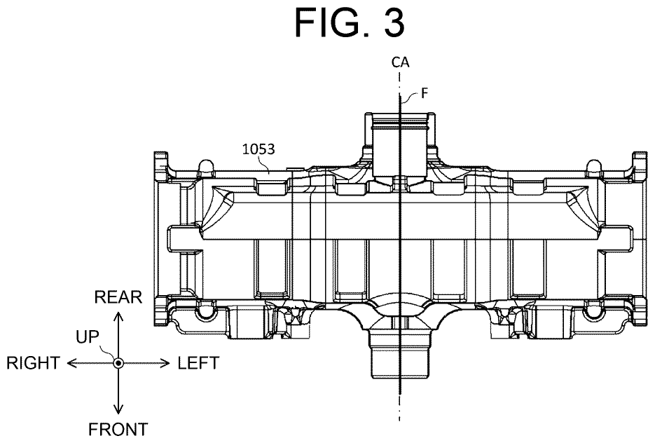

Next, a configuration example of the front axle 105 will be described with reference to FIGS. 2A to 3. FIG. 2A is a cross-sectional view of a configuration example of the front axle 105 as viewed from the upper side. FIG. 2B is a cross-sectional view of another configuration example of the front axle 105 as viewed from the upper side. FIG. 3 is a cross-sectional view of a configuration example of an inner peripheral surface of the front axle case 1053 as viewed from the upper side. FIG. 2A illustrates the configuration example of the front axle 105 in which an input shaft 1054 is rotated clockwise as viewed from the rear side when the tractor 100 moves forward. FIG. 2B illustrates the configuration example of the front axle 105 in which the input shaft 1054 is rotated counterclockwise as viewed from the rear side when the tractor 100 moves forward.

As illustrated in FIGS. 2A and 2B, the front axle 105 includes the front axle case 1053, the input shaft 1054, a pair of left and right axles 1052. The front axle 105 of the present embodiment is of a swing axle type and follows the shape of a road surface when the tractor 100 travels, and thus can swing in the up-down direction.

The front axle case 1053 has a cylindrical shape extending in an axial direction J (e.g., at least in the left-right direction) in which the axles 1052 of the front wheels 1051 extend, and houses the pair of left and right axles 1052 and a differential gear 1055. The front axle case 1053 can swing in the up-down direction.

The input shaft 1054 is a rotating shaft extending in the front-rear direction. A rear end portion of the input shaft 1054 is connected to an end portion of the propeller shaft 1041 of the transmission 104. A front end portion of the input shaft 1054 is inserted into an opening provided on an outer peripheral surface of the front axle case 1053. The rotational power of the engine 103 is transmitted from the propeller shaft 1041 to the input shaft 1054. The rotational power is transmitted to each of the axles 1052 via the differential gear 1055.

In the tractor 100, as described above, the rotational power of the engine 103 is transmitted from the propeller shaft 1041 of the transmission 104 to the axles 1052 of the front axle 105. The direction of rotation of the axles 1052 depends on the direction of rotation transmitted from the propeller shaft 1041.

However, as illustrated in FIGS. 2A and 2B, the rotation direction of the propeller shaft 1041 when the tractor 100 moves forward (or moves backward) may vary depending on the tractor 100. In such a case, the placement and orientation of the differential gear 1055 in the front axle case 1053 vary, and thus it is difficult to share the components of the front axle 105. That is, the front axle 105 to be used needs to vary according to the rotation direction of the propeller shaft 1041 (and the input shaft 1054).

In order to solve the above-described problem, in the present embodiment, as illustrated in FIG. 3, the inner peripheral surface of the front axle case 1053 preferably has a mirror symmetrical shape with respect to a virtual plane F. The virtual plane F includes a central axis CA of the input shaft 1054 and is parallel to the up-down direction. Thus, the components of the front axle 105 can be shared regardless of the rotation direction of the propeller shaft 1041 (and the input shaft 1054).

For example, in the case where the input shaft 1054 is rotated clockwise as viewed from the rear side when the tractor 100 moves forward, as illustrated in FIG. 2A, the differential gear 1055 is disposed on the left side of the central axis CA of the input shaft 1054 in the front axle case 1053. On the other hand, in the case where the input shaft 1054 is rotated counterclockwise as viewed from the rear side when the tractor 100 moves forward, as illustrated in FIG. 2B, the orientation of the differential gear 1055 is different from that in FIG. 2A, and the differential gear 1055 is disposed on the right side of the central axis CA of the input shaft 1054 in the front axle case 1053. That is, the components of the front axle 105 may vary in placement and orientation but can be shared.

However, the examples in FIGS. 2A to 3 do not exclude a configuration in which the inner peripheral surface of the front axle case 1053 of the present embodiment does not have a mirror symmetrical shape with respect to the virtual plane F.

### <1-3. Power Steering Mechanism 107>

Next, the tractor 100 further includes a power steering (PST) mechanism 107. FIG. 4 is a perspective view of a configuration example of the power steering mechanism 107. The PST mechanism 107 is connected to the steering wheel 1022, and assists steering of the steering wheel 1022 performed by the operator. The PST mechanism 107 allows the operator to steer the tractor 100 with lighter force. When the wheels receive an impact, the PST mechanism 107 can reduce the impact transmitted to the steering wheel 1022.

The PST mechanism 107 includes a steering shaft 1023, a power steering (PST) valve 1, a pair of left and right supply pipes 2, and a power steering (PST) cylinder 3.

The steering shaft 1023 transmits the rotation direction (steering direction) of the steering wheel 1022 to the PST valve 1. An upper end portion of the steering shaft 1023 is connected to the steering wheel 1022. A lower end portion of the steering shaft 1023 is connected to the PST valve 1.

The PST valve 1 is a hydraulic valve that supplies hydraulic oil to the PST cylinder 3 via the supply pipes 2. The PST valve 1 is supplied from a hydraulic pump (not illustrated) with hydraulic oil having a hydraulic pressure required to steer the wheels 1051, and sends, to each of the supply pipes 2, an amount of hydraulic oil corresponding to the direction and amount of rotation (steering) of the steering wheel 1022.

The supply pipes 2 are each a cylindrical pipe member that connects the PST valve 1 to the PST cylinder 3. A first end portion of each of the supply pipes 2 is connected to the PST valve 1. A second end portion of the right supply pipe 2 is connected to a right side portion of the PST cylinder 3. A second end portion of the left supply pipe 2 is connected to a left side portion of the PST cylinder 3. In each of the supply pipes 2, hydraulic oil flows from the PST valve 1 toward the PST cylinder 3.

The PST cylinder 3 is attached to the outer peripheral surface of the front axle case 1053 having a cylindrical shape, and extends, together with the front axle case 1053, parallel to the axial direction J (e.g., left-right direction) of the axles 1052.

The PST cylinder 3 includes a cylinder portion 31, and a pair of left and right rods 32. The cylinder portion 31 has a cylindrical shape extending in the axial direction J, and is fixed to the front axle case 1053. Each of the rods 32 has a columnar shape extending in the axial direction J. An inner side end portion of each of the rods 32 in the axial direction J is housed in the cylinder portion 31. An outer side end portion of each of the rods 32 in the axial direction J is connected to a knuckle arm (not denoted) of the front wheels 1051. The rods 32 advance and retreat (in other words, enter and exit) in the axial direction J with respect to the cylinder portion 31 according to the amount of hydraulic oil supplied from the PST valve 1 into the cylinder portion 31. Thus, the travel direction of the front wheels 1051 is changed.

### <1-3-1. Supply Pipe 2>

Next, a configuration of the right supply pipe 2 will be described. The right supply pipe 2 includes a flexible pipe 21 and a rigid pipe 22. The flexible pipe 21 can be bent according to the swing of the front axle case 1053. The rigid pipe 22 cannot be bent according to the swing of the front axle case 1053.

The flexible pipe 21 is more flexible than the rigid pipe 22. On the other hand, the flexible pipe 21 is less rigid than the rigid pipe 22. The flexible pipe 21 has high flexibility, and is, for example, a rubber hose, or a bellows pipe made of resin or metal. The rigid pipe 22 has high rigidity and low flexibility, and is, for example, a metal pipe having a thick pipe wall.

A first end portion of the rigid pipe 22 is connected to the cylinder of the PST cylinder 3. A second end portion of the rigid pipe 22 is connected to a first end portion of the flexible pipe 21. Thus, the swing of the front axle case 1053 does not cause relative displacement or bending of the rigid pipe 22 with respect to the front axle case 1053. Therefore, the rigid pipe 22 swings in a clearance within the expected range, and does not interfere with a peripheral component disposed near the front axle case 1053. On the other hand, relative displacement of the PST cylinder 3 with respect to the PST valve 1 caused by the swing of the front axle case 1053 is eliminated by displacement and bending of the flexible pipe 21 at a position away from the front axle case 1053. Thus, even when the front axle case 1053 swings, it is possible to prevent interference of the supply pipe 2 with a peripheral component disposed near the front axle case 1053.

In the present embodiment, a second end portion of the flexible pipe 21 is connected to the PST valve 1. However, the present invention is not limited to this example, and the second end portion of the flexible pipe 21 may be connected to another rigid pipe. For example, one or more rigid pipes and one or more flexible pipes may be connected in series between the PST valve 1 and the second end portion of the flexible pipe 21.

The rigid pipe 22 is preferably disposed above a lower end of the front axle case 1053. This makes it possible to reliably prevent at least part of the rigid pipe 22 from being disposed below the axle case 1053 in the up-down direction. Thus, it is possible to prevent the rigid pipe 22 from being damaged by contact with the road surface (ground) when the tractor 100 travels.

A first connection portion 23 between the second end portion of the rigid pipe 22 and the first end portion of the flexible pipe 21 is preferably disposed behind the front axle case 1053. Thus, it is possible to use the rigid pipe 22 for a portion of the supply pipe 2 that includes the second end portion on the PST cylinder 3 side and is located near the front axle case 1053 and use the flexible pipe 21 for a portion of the supply pipe 2 that includes the first end portion connected to the rigid pipe 22 and is located on the PST valve side and away from the front axle case 1053. Therefore, when the front axle case 1053 swings, it is possible to more effectively prevent interference of the supply pipe 2 (particularly the rigid pipe 22) with a peripheral component. Furthermore, relative displacement of the PST cylinder 3 with respect to the PST valve 1 caused by the swing of the front axle case 1053 is more easily eliminated by displacement and bending of the flexible pipe 21.

The front axle 105 of the tractor 100 preferably includes a fixing member 24 that fixes the second end portion of the rigid pipe 22 to an outer surface of the front axle case 1053. Thus, it is possible to fix both end portions of the rigid pipe 22 that cannot be bent according to the swing of the front axle case 1053. For example, the first end portion of the rigid pipe 22 is connected and fixed to the PST cylinder 3. Furthermore, the second end portion of the rigid pipe 22 is fixed to the outer surface of the front axle case 1053 by the fixing member 24. Thus, even when the front axle case 1053 swings, the rigid pipe 22 swings following the front axle case 1053. This makes it possible to reliably prevent relative displacement and bending of the rigid pipe 22 with respect to the front axle case 1053.

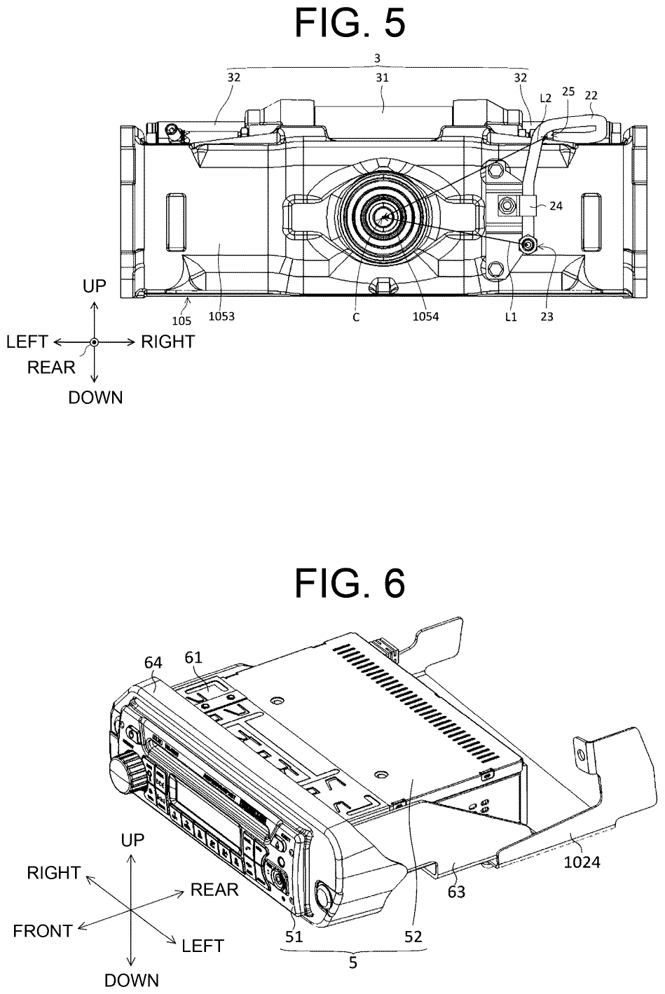

The first connection portion 23 between the second end portion of the rigid pipe 22 and the first end portion of the flexible pipe 21 is preferably closer to a swing center C of the front axle case 1053 than a second connection portion 25 between the first end portion of the rigid pipe 22 and the PST cylinder 3 as viewed in the front-rear direction. FIG. 5 is a rear view of the front axle 105 as viewed from the rear side. For example, as illustrated in FIG. 5, a shortest distance (i.e., projection distance) L1 between the swing center C of the front axle case 1053 and the first connection portion 23 in rear view is shorter than a shortest distance (projection distance) L2 between the swing center C of the front axle case 1053 and the second connection portion 25 in rear view. That is, L1<L2.

Thus, it is possible to achieve a shorter swing distance of the first connection portion 23 that swings following the front axle case 1053. The swing distance is the displacement amount in a swing direction (i.e., circumferential direction) around the swing center C of the front axle case 1053. This makes it possible to achieve a smaller displacement range of the first connection portion 23 and further achieve a smaller relative displacement amount of the first connection portion 23 with respect to the PST valve 1. Thus, it is possible to further prevent interference of the supply pipe 2 with another component.

However, the above-described example does not exclude a configuration in which L1≥L2.

In the present embodiment, the right supply pipe 2 has the above-described configuration. On the other hand, the left supply pipe 2 is composed of a flexible pipe (e.g., rubber pipe). However, the present invention is not limited to this example, and the left supply pipe 2 may have the same configuration as the right supply pipe 2 and include, for example, the flexible pipe 21 and the rigid pipe 22 connected to the PST cylinder.

### <1-4. Attachment Example of Audio Device 5>

Next, in the case where the tractor 100 is, for example, a cabin type tractor, an audio device 5 is disposed in a box-shaped steering cabin (i.e., boarding portion 102).

When an audio device is attached in a conventional manner, for example, a bracket is screwed to both side surfaces of a cylindrical audio cover in the left-right direction that surrounds a front portion of the audio device, and the bracket is fixed to the boarding portion 102. However, the placement of screw holes of an audio cover or the like varies depending on the model number, manufacturer, or the like of an audio device. Thus, different brackets need to be used according to the model number, manufacturer, or the like of an audio device to be attached.

In order to solve the above-described problem, in the present embodiment, the audio device 5 can be attached to the boarding portion 102 using the same type of attachment member (bracket etc.) by the same method, regardless of the model number, manufacturer, or the like of the audio device 5.

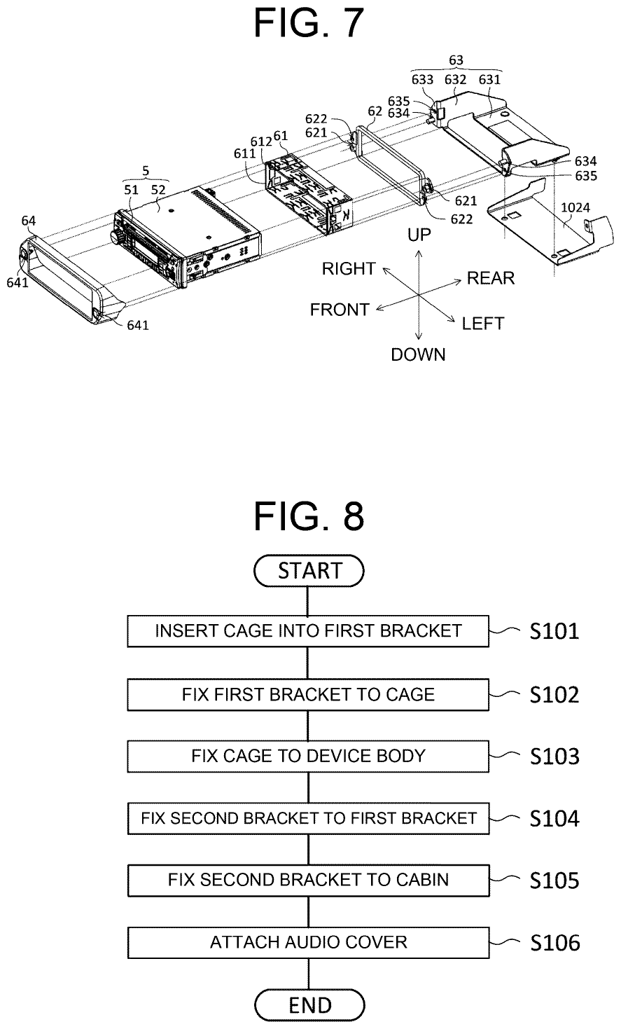

An attachment example of the audio device 5 disposed in the boarding portion 102 will be described with reference to FIGS. 6 to 8. FIG. 6 is an external view of an example of the audio device 5 attached to the boarding portion 102. FIG. 7 is an exploded perspective view of an example of an attachment structure of the audio device 5. FIG. 8 is a flowchart illustrating an example of a method of attaching the audio device 5.

The audio device 5 includes an operation panel 51 and a device body 52. The operation panel 51 is attached to a front end portion of the device body 52. An outer edge portion of the operation panel 51 is larger than an outer edge portion of the front end portion of the device body 52 as viewed in the front-rear direction.

When the audio device 5 is attached to the boarding portion 102, first, a cage 61 that has a rectangular tubular shape and extends in the front-rear direction is inserted into a first bracket 62 that has a frame shape (step S101). A guard portion 611 that extends outward is disposed at an outer edge of a front end portion of the cage 61. The cage 61 is inserted into the first bracket 62 until the first bracket 62 is brought into contact with the guard portion 611.

A plurality of claw portions 612 that can be bent and raised are disposed on an outer surface of the cage 61. The claw portions 612 close to the first bracket 62 are bent and raised to fix the first bracket 62 to the front end portion of the cage 61 (step S102).

Then, the device body 52 is inserted into the cage 61, and the cage 61 is fixed to a front side portion of the device body 52 (step S103). At this time, the device body 52 is inserted into the cage 61 until the front end portion of the cage 61 is brought into contact with the operation panel 51. Thus, the cage 61 and the first bracket 62 are attached to the audio device 5 (the front end portion of the device body 52).

Next, a second bracket 63 is fixed to the first bracket 62 (step S104). For example, in the present embodiment, openings are provided in both end portions of the first bracket 62 in the left-right direction. The second bracket 63 includes a bottom plate 631 that extends in the front-rear direction and in the left-right direction, a pair of left and right side plates 632 that protrude upward from an end portion of the bottom plate 631 in the left-right direction and extend in the front-rear direction, and guard portions 633 that extend outward in the left-right direction from front ends of the respective side plates 632. Furthermore, each of the guard portions 633 has an opening 634. The first bracket 62 is placed in a space surrounded by the bottom plate 631 and the pair of left and right side plates 632 of the second bracket 63. Then, the first bracket 62 and the second bracket 63 are bolted together while openings 621 of the first bracket 62 are overlapped with the openings 634 of the second bracket 63. Thus, the second bracket 63 can be fixed to the first bracket 62.

Then, the second bracket 63 is fixed to an attachment portion 1024 of the boarding portion 102 by screwing or the like (step S105).

Furthermore, an audio cover 64 is fixed to a front end portion of the audio device 5 (step S106). The audio cover 64 has a bottomed cylindrical shape, and a bottom portion of the audio cover 64 has an opening in which a front surface of the operation panel 51 is exposed. Front end portions of the operation panel 51 and the first bracket 62 are fitted into the audio cover 64. Then, the first bracket 62, the second bracket 63, and the audio cover 64 are bolted together while openings 622 of the first bracket 62, openings 635 of the second bracket 63, and openings 641 of the audio cover 64 are overlapped with each other, and thus the audio cover 64 is fixed to the audio device 5.

The audio device 5 can be attached to the boarding portion 102 by the above-described procedure.

The above-described attachment process enables the audio device 5 to be attached to the boarding portion 102 by a means in accordance with the ISO, without the necessity of a dedicated bracket according to the model number, manufacturer, or the like of the audio device 5.

### 2. Remarks

The embodiment of the present invention has been described above. It should be understood by those skilled in the art that the above-described embodiment is merely an example and various modifications can be made to a combination of components and processes thereof and are within the scope of the present invention.

In the above-described embodiment, the present invention is applied to the tractor 100. However, the present invention is not limited to this example, and the present invention can also be applied to a device other than the tractor 100. The present invention can also be applied to, for example, an agricultural work machine such as a rice transplanter or a combine harvester, or a vehicle for special work such as a wheel loader.

### 3. Overview

The above-described embodiment will be collectively described below.

For example, the tractor 100 disclosed herein has a configuration (first configuration) in which the tractor 100 includes:
the axle case 1053 that houses the axle 1052 of the wheel 1051;
the hydraulic cylinder 3 that is attached to the axle case 1053;
the hydraulic valve 1 that supplies hydraulic oil to the hydraulic cylinder 3; and
the supply pipe 2 that connects the hydraulic valve 1 to the hydraulic cylinder 3 and through which the hydraulic oil flows, wherein
the supply pipe 2 includes the flexible pipe 21 and the rigid pipe 22,
a first end portion of the rigid pipe 22 is connected to the hydraulic cylinder 3, and
a second end portion of the rigid pipe 22 is connected to the first end portion of the flexible pipe 21.

The tractor 100 having the first configuration may have a configuration (second configuration) in which
the rigid pipe 22 is disposed above a lower end of the axle case 1053.

The tractor 100 having the first or second configuration may have a configuration (third configuration) in which
the first connection portion 23 between the second end portion of the rigid pipe 22 and the first end portion of the flexible pipe 21 is disposed behind the axle case 1053.

The tractor 100 having any one of the first to third configurations may have a configuration (fourth configuration) in which the tractor 100 further includes
a fixing member 24 that fixes the second end portion of the rigid pipe 22 to an outer surface of the axle case 1053.

The tractor 100 having any one of the first to fourth configurations may have a configuration (fifth configuration) in which
the first connection portion 23 between the second end portion of the rigid pipe 22 and the first end portion of the flexible pipe 21 is closer to the swing center C of the axle case 1053 than the second connection portion 25 between the first end portion of the rigid pipe 22 and the hydraulic cylinder 3 as viewed in a front-rear direction.

### REFERENCE SIGNS LIST

100 Tractor
101 Frame
102 Boarding portion
1021 Seat
1022 Steering wheel
1023 Steering shaft
1024 Attachment portion
103 Engine
1031 Hood
104 Transmission
1041 Propeller shaft
105 Front axle
1051 Front wheel (wheel)
1052 Axle
1053 Front axle case (axle case)
1054 Input shaft
1055 Differential gear
106 Rear axle
1061 Rear wheel
107 Power steering mechanism
1 PST valve (hydraulic valve)
2 Supply pipe
21 Flexible pipe
22 Rigid pipe
23 First connection portion
24 Fixing member
25 Second connection portion
3 PST cylinder (hydraulic cylinder)
31 Cylinder portion
32 Rod
5 Audio device
51 Operation panel
52 Device body
61 Cage
611 Guard portion
612 Claw portion
62 First bracket
621, 622 Opening
63 Second bracket
631 Bottom plate
632 Side plate
633 Guard portion
634, 635 Opening
64 Audio cover
641 Opening
C Swing center
J Axial direction
CA Central axis

1. A work vehicle comprising:
an axle case that houses an axle of a wheel;
a hydraulic cylinder that is attached to the axle case;
a hydraulic valve that supplies hydraulic oil to the hydraulic cylinder; and
a supply pipe that connects the hydraulic valve to the hydraulic cylinder and through which the hydraulic oil flows, wherein
the supply pipe includes a flexible pipe and a rigid pipe,
a first end portion of the rigid pipe is connected to the hydraulic cylinder, and
a second end portion of the rigid pipe is connected to a first end portion of the flexible pipe.

2. The work vehicle according to claim 1, wherein
the rigid pipe is disposed above a lower end of the axle case.

3. The work vehicle according to claim 1, wherein
a first connection portion between the second end portion of the rigid pipe and the first end portion of the flexible pipe is disposed behind the axle case.

4. The work vehicle according to claim 1, further comprising
a fixing member that fixes the second end portion of the rigid pipe to an outer surface of the axle case.

5. The work vehicle according to claim 1, wherein
a first connection portion between the second end portion of the rigid pipe and the first end portion of the flexible pipe is closer to a swing center of the axle case than a second connection portion between the first end portion of the rigid pipe and the hydraulic cylinder as viewed in a front-rear direction.
